(19) United States
(12) Patent Application Publication
(10) Pub. No.: US 2003/0219322 A1
(43) Pub. Date: Nov. 27, 2003

(54) Device for the automatic assignment of the position of a machining tool to a work-piece

(76) Inventors: Manfred Zankl, Obergunzburg (DE); Klaus Spiess, Altusried (DE)

Correspondence Address: Rocco S. Barrese, Esq., DILWORTH & BARRESE, LLP, 333 Earle Ovington Blvd., Uniondale, NY, 11553, US

(21) Appl. No.: 10/383,970

(22) Filed: Mar. 7, 2003

(30) Foreign Application Priority Data
Mar. 7, 2002 (DE) 202 03 661.8

(51) Int. Cl. B23F 5/00

(52) U.S. Cl. 409/38

(57) ABSTRACT

The invention relates to a device for the automatic assignment of the position of a rotating tool with respect to pre-machined toothing of a work-piece to be machined. According to the invention, the tool can be introduced in an arbitrary position between the tooth flanks. In a touch mode, the distance from the feed-in position to the tooth flanks can be determined by relative rotation of the work-piece to the tool and the desired target position of the tool can be calculated from this value.

The invention relates to a device for the automatic assignment of the position of a rotating tool with respect to pre-machined toothing of a work-piece to be machined.

With known rotating machining tools, such as for example grinding wheels for the machining of tooth flanks of a gear wheel, the first engagement of the grinding wheel and the pre-machined toothing of the work-piece to be machined generally takes place manually, i.e. the visually, when the machine tool is at a standstill. Various attempts have already been made to automate the so-called manual centring of the rotating machining tools between the pre-machined toothing of the work-piece to be machined.

It is known from DE 27 44 562 B2, for example, that a measurement transmitter, which can be introduced between the tool and the work-piece, has one pair of nozzles for the tool and one pair of nozzles for the work-piece, said pairs of nozzles pneumatically measuring a differential pressure, whereby each pair of nozzles includes an adjustable reference nozzle and a measurement nozzle, directable respectively at the tool and the work-piece, for generating a signal corresponding to the differential pressure and fed to the identification circuit. This solution is costly, since additional measurement transmitters have to be provided, which make the overall device more expensive and which moreover are susceptible to malfunction.

The problem of the invention, therefore, is to make available a generic device which enables, if possible without additional measurement transmitters, an automatic assignment of the position of the machining tool to a work-piece.

According to the invention, this problem is solved with a generic device by the combination of the features of claim 1. Accordingly, the automatic assignment of the position of a rotating tool with respect to pre-machined toothing of a work-piece to be machined is enabled in a simple manner by the fact that the tool can be introduced in an arbitrary position between the tooth flanks and that, in a touch mode, the distance from the feed-in position to the tooth flanks can be determined by relative rotation of the work-piece to the tool and the desired target position of the tool can be calculated from this value. By means of this solution, therefore, the tool can be fed in at an arbitrary point of the tooth space of pre-machined toothing. By starting the touch mode, i.e. by to-and-fro movement of the gear wheel work-piece to be machined, the precise position of the rotating machining tool is then determined by touching the respective position of the tooth flanks adjacent to the tooth space. Furthermore, for the centring of the tool in the tooth space, the correction value can be calculated by which the tool must be rotated in order that the rotating tool lies in the desired centred position.

Preferred developments of the invention will emerge from the subclaims following the main claim.

To particular advantage, the rotating tool is fed in, for the positioning, to different depths between the flanks of the pre-machined toothing of the work-piece to be machined. The touch mode can thus be determined with an initially small insertion depth of the tool into the tooth space. Following this preliminary determination, the rotating tool can then be inserted deeper into the tooth space in order to repeat the touching procedure again.

Further details and advantages of the invention will be explained in greater detail with the aid of two examples of embodiment represented diagrammatically in the drawing.

The following are shown:

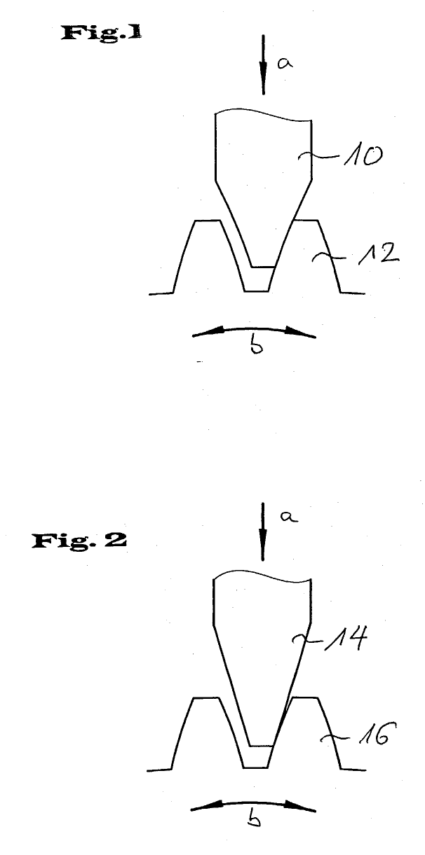

FIG. 1: a diagrammatic detail representation of the engagement of the shaping tool in a gear wheel to be machined and

FIG. 2: the engagement of a hobbing tool in the tooth space of a gear wheel to be machined.

Two different tool forms of the rotating machining tools are represented diagrammatically in FIGS. 1 and 2. In the upper part, a grinding wheel 10 is represented as a typical shaping tool, the profile of which is an involute. When such tools are used, grinding takes place space by space and the shape of tool 10 is reproduced directly in work-piece 12.

FIG. 2 shows the use of a hobbing tool 14. The tool flank here is designed straight. The involute to be produced in work-piece 16 emerges with the machining as an envelope curve through a hobbing motion. The case of application for such a hobbing tool would, for example, be grinding worms, which are used for rolling-grinding. Such grinding worms are straight-sided tools.

The automatic centring of rotating machining tools 10 and 14 respectively in the tooth spaces of the pre-machined toothing of work-pieces 12 and 16 to be machined takes place as follows with the device according to the invention:

Before the automatic centring, the operator must, when prompted, check whether the tool fits into the tooth space of the pre-machined toothing. This means that the tool must be able to be inserted into the tooth space at least approx. one third of the insertion depth without collision. If the rotating tool is arranged directly opposite a tooth, the tool-holder table (not represented in the figures) must be moved away by approx. ⅙ of a tooth. After this initial positioning, the automatic centring procedure is started. The moment of the tool-holder table is first reduced and the rotating tool is inserted into the tooth space by approx. ¼ the depth of the tooth space in the direction of arrow a according to FIG. 1 and FIG. 2. The advance of the device is set to a certain touch mode, whereby the rotational speed of the tool-holder table is also reduced. The tool-holder table travels slowly in the direction of two-headed arrow b (see FIG. 1 and FIG. 2 respectively) to the right-hand tooth flank. After reaching the right-hand tooth flank, the tool-holder table travels slowly in the opposite direction until tool 10 and 14 respectively lie adjacent to the left-hand tooth flank. After both tooth flanks have been touched, the touch mode is switched off and the travel speed and the moment of the tool-holder table are returned to the original values. The midpoint between the tooth flanks is calculated and the rotating tool is correspondingly positioned in the midpoint.

If no tooth flanks or only one has been found, the operator is notified and asked whether he wishes to continue with ⅔ insertion depth into the tooth space. The moment and speed of the tooth-holder table is again reduced and the rotating tool is inserted ⅔ into the tooth space in the direction of arrow a in FIGS. 1 and 2 respectively. The touch mode is again established and the tool-holder table is slowly moved in the direction of arrow b to the right-hand tooth flank and after reaching the right-hand tooth flank slowly to the left-hand tooth flank. The so-called touch mode is then again switched off and the original speed and the original moment of the tool-holder table are set. By means of a processor not described in any detail here, the midpoint value between the tooth flanks is calculated and the tool-holder table is now positioned at this midpoint value, as a result of which the automatic centring procedure is completed, so that the automatic machining process of the pre-machined toothing can immediately follow.

1. A device for the automatic assignment of the position of a rotating tool with respect to pre-machined toothing of a work-piece to be machined,
characterised in that
the tool can be introduced in an arbitrary position between the tooth flanks and that, in a touch mode, the distance from the feed-in position to the tooth flanks can be determined by relative rotation of the work-piece to the tool and the desired target position of the tool can be calculated from this value.

2. The device according to claim 1, characterised in that the desired target position is the midpoint position of the rotating tool between the two flanks of the pre-machined toothing of the work-piece to be machined.

3. The device according to claim 1 or 2, characterised in that the tool can be conveyed to the tooth flank until a positive stop in the touch mode with lower rotational speed of the work-piece.

4. The device according to any one of claims 1 to 3, characterised in that, for the positioning, the rotating tool can be fed in to different depths between the flanks of the pre-machined toothing of the work-piece to be machined according to established program steps.
